(19) United States
(12) Patent Application Publication
(10) Pub. No.: US 2018/0027619 A1
(43) Pub. Date: Jan. 25, 2018

(54) ARCING PROTECTOR

(71) Applicant: UNIVERSAL LIGHTING TECHNOLOGIES, INC., NASHVILLE, TN (US)

(72) Inventors: WEI XIONG, MADISON, AL (US); TRAVIS BERRY, MADISON, AL (US); KEITH DAVIS, MADISON, AL (US)

(73) Assignee: Universal Lighting Technologies, Inc.

(21) Appl. No.: 15/217,700

(22) Filed: Jul. 22, 2016

(51) Int. Cl. H05B 33/08; H02H 7/10; H02H 11/00; H02M 1/32

(52) U.S. Cl. CPC H05B 33/0815; H02M 1/32; H02H 7/10; H02H 11/006

(57) ABSTRACT

Examples of the present disclosure relate to a device, method, and medium storing instructions for execution by a processor for protecting a driver from arcing. For example, a device for protecting a driver from arcing may include a gate drive circuit connected to a high-side switch and a low-side switch to control to operation of a converter in the device. The device may also include a processor to send a control signal to the gate drive circuit when the processor receives an indication of arcing from a voltage sensor in the device, the control signal to delay an operation by the converter.

### FIELD OF THE INVENTION

The present disclosure generally relates to a method, system, and device used to protect a driver from arcing damage. More specifically, the present disclosure relates protecting a driver from arcing damage that can be experienced while powering on or rapidly going through no-load, startup, and loaded states.

### BACKGROUND OF THE INVENTION

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Arcing can occur as sparks when current-carrying contacts are separated. This spark can be a luminous discharge of highly energized electrons and ions, and is an electric arc. When an electrical power device turns on or off or rapidly goes through no-load, startup, and loaded states, the device's switch, relay, or contactor can transition from a closed to an open state or from an open to a closed state. The arc can be an electrical arc and can be destructive and can occur between the two contact points, or electrodes, of the switch. Specifically, the energy contained in the resulting electrical arc can be very high, causing the metal on the contact surfaces to melt, pool, and migrate with the current. The arc energy can slowly destroy the contact metal, causing some material to escape into the air as fine particulate matter. Arcing can also cause the material in the contacts to degrade quickly, resulting in device failure.

Bad input and output connections in a device can cause continuous input and output arcing. When input arcing happens, a circuit may start and stop, and these starts and stops can cause stress on switches or even damage to the device. For example, if input arcing happens, there may be a big current spike. Similarly, when output arcing happens, the load condition of the circuit can change through no-load, startup, loaded states. Rapid operating state changes can also induce a high current spike that adds stress to switches and can damage the device. The present disclosure presents techniques to protect from arcing damage and effects.

### SUMMARY OF THE INVENTION

One example can include a device to protect a driver from arcing. The device may include a gate drive circuit connected to a high-side switch and a low-side switch to control to operation of a converter in the device. As used herein, the operation of the converter is the start-up or powering-up of the converter and the processing through the no-load, startup, and loaded states of the converter. The device may also include a processor to send a control signal to the gate drive circuit when the processor receives an indication of arcing from a voltage sensor in the device, the control signal to delay an operation by the converter.

In another example, a method for protecting a driver from arcing may include controlling a current output of a converter with a gate drive signal from a gate drive circuit to a connected high-side switch and a connected low-side switch. A method for protecting a device from arcing may also include sending a control signal from a processor to a gate drive circuit when the processor receives an indication of arcing from a voltage sensor in the device. The method may also include delaying an operation by the converter when the gate drive circuit receives the control signal.

In another example, a tangible, non-transitory, computer-readable medium can include instructions that, when executed by a processor, direct the processor to protect a driver from arcing. The instructions can direct the processor to control a current output of a converter with a gate drive signal from a gate drive circuit to a connected high-side switch and a connected low-side switch. The instructions may send a control signal from the processor to a gate drive circuit when the processor receives an indication of arcing from a voltage sensor in the device. The instructions may delay an operation by the converter when the gate drive circuit receives the control signal.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, wherein:

FIG. 1 is a drawing of an example diagram of a system for a device to protect a driver from arcing;

FIG. 2 is a process flow diagram of an example method of a microcontroller to protect a driver from arcing;

FIG. 3 is a drawing of an example detection of a signal and delay to protect a driver from input arcing;

FIG. 4 is a drawing of an example detection of a signal and delay to protect a driver from output arcing;

FIG. 5 is a process flow diagram of an example method to protect a driver from arcing; and

FIG. 6 is a drawing of an example computer-readable medium storing instructions, that when executed on a processor protect a driver from arcing.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure can be seen below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

Some power converters may have drawbacks in that the maximum stress on half-bridge metal-oxide-semiconductor field-effect transistors (MOSFETs) cause stress on switches at the device's startup. In a direct current to direct current (DC-DC) power converter with a power tank, there may be no power in the power tank before the converter powers on. If there is no power in the power tank and a switch is between a power bank and the power source, a large current spike can go through this switch, for example, a high side MOSFET switch, during start up in order to charge up the power tank.

During an initial start-up of a converter, there may be a couple of cycles of high current going through switches. This high current spike can be very stressful and harmful. If a MOSFET continuously conducts this kind of high current, its life can be greatly reduced. Further, bad input and output connections can cause continuous input and output arcing. As described above, when input arcing happens, a converter and the components in the converter can start and stop. As previously described, this kind of continuous converter on-off cycle can put a big stress on the switches of the converter and can cause, for example, a light emitting diode (LED) driver to fail more rapidly than without this stress being applied. A similar situation can happen with output arcing. With output arcing the load condition can change very rapidly so that the half-bridge MOSFETs can rapidly go through no-load, startup, and loaded states. The rapid operating state change can induce a high current spike through switches of the converter and put a stress on switches that lower the reliability of the driver. For both input arcing and output arcing, there may be a big current spike going through a high-side switch, for example. As you can see from the discussion above, it is very desirable to protect the driver from being damaged when input-arcing and output-arcing happen.

As disclosed herein, one way to protect switches from being damaged in input and output arcing situations can include putting a delay for re-start-up whenever an arcing is sensed by a microcontroller. By doing this, the converter may not start-up as often as a converter without these protections. As described and shown in the figures below, protection from arcing can include using output voltage changing rate as an indicator for output arcing, using a boost inductor winding voltage as an indicator for input arcing, and a microcontroller that can sense the output voltage changing rate to tell if an output arcing is happening or not. The microcontroller can also sense the boost winding voltage changing rate to tell if an input arcing is happening or not and may force a delay for next startup whenever it senses an input or output arcing.

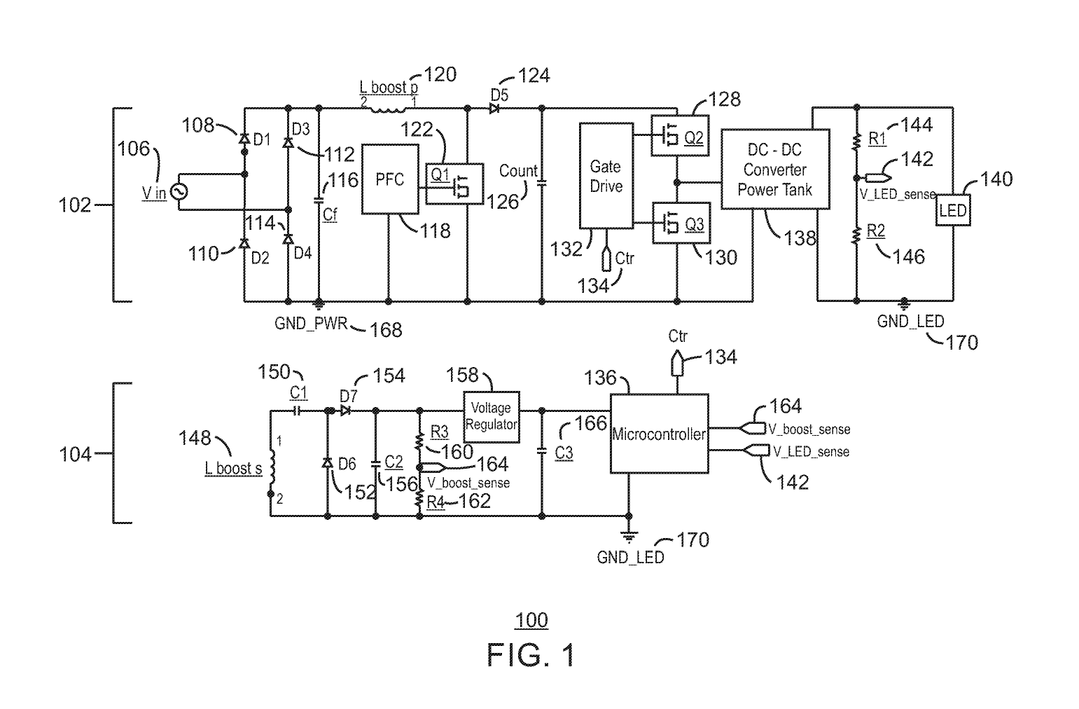

FIG. 1 is a drawing of an example diagram of a system 100 for a device to protect a driver from arcing. As shown in FIG. 1, two parts of this system 100 can include a converter circuit 102 and a microcontroller circuit 104. The converter circuit 102 can include a power source 106. As shown in FIG. 1, the power source can be an alternating current (AC) power source with an AC voltage. The converter circuit 102 may accept AC voltage as an input and convert it to un-regulated direct current (DC) voltage.

The converter circuit 102 can include an input rectifier diode D1 108, an input rectifier diode D2 110, an input rectifier diode D3 112, and an input rectifier diode D4 114. These input rectifier diodes can rectify input AC voltage to an un-regulated DC voltage. The converter circuit 102 may also include a high frequency filter capacitor (Cf) 116 that may pass signals with a frequency higher than a certain cutoff frequency and attenuate signals with frequencies lower than the cutoff frequency. The converter circuit 102 may also include a power factor correction (PFC) circuit 118 in between the input AC voltage 106 and DC-DC converter stage. The PFC 118 may be an integrated circuit and may bring the power factor of an AC power 106 closer to 1 by supplying reactive power of opposite sign and by adding capacitance or inductance to cancel the inductive or capacitive effects of the load.

The converter circuit 102 may include a primary boost inductor (L_boost_p) 120. L_boost_p 120 can be any suitable boost converter including an inductor, a capacitor, or any suitable combination. The converter circuit 102 can include a switch such as Q1 122 connected to the PFC 118. A diode D5 124 can be a boost diode, such as a high-side switch. The PFC 118 can be an integrated circuit that drives Q1 122 to force input current to follow the input voltage to achieve high power factor. The converting circuit 102 can include an output capacitor of the PFC 118 circuit, Cout 126. Cout 126 can be the output of the PFC circuit and the input of the DC-DC converter stage.

The converter circuit 102 may include a high side switch Q2 128 and a low side switch Q3 130 to act as switches for a half-bridge of the converter circuit 102. A gate drive 132 can drive Q2 128 and Q3 130 according a control signal 134 (Ctr), which can come from a microcontroller 136. The converter circuit 102 can include a DC-DC converter power tank 138 to store power and provide a voltage to an LED 140. The LED circuit portion can also include, in parallel to the LED, a detector of voltage to send back a signal to the microcontroller (V_LED_sense) 142. On output voltage sensor, here V_LED_sense 142, can be placed in parallel to an output to monitor voltage differences and fluctuations. The V_LED_sense can provide an output voltage sensing signal to sense rapid change in the output voltage. Rapid change of an output voltage can occur during the output arcing. To aid in the voltage sensing, the output voltage sensor circuit can include resistor R1 144 and a resistor R2 146.

As mentioned above, the system 100 can include a microcontroller circuit 104 including a microcontroller 136. The microcontroller circuit 104 can include a secondary boost inductor (L_boost_s) 148. L_boost_s 148 is an auxiliary winding of the boost inductor L_boost_p 120. The winding, L_boost_s 148, is inductively coupled but electrically isolated from the primary winding L_boost_p 120. L_boost_s 148 can be used to provide power for microcontroller 136. L_boost_s 148 can be any suitable boost converter including an inductor, a capacitor, or any suitable combination.

The microcontroller circuit 104 can include a charging capacitor C1 150, a charging diode D6 152, and a pump diode D7 154, all of which form a simple charge pump circuit. A capacitor C2 156 can mirror the peak-to-peak voltage of L_boost_s 148. A voltage regulator 158 regulates the voltage across C2 156 to an acceptable voltage to supply microcontroller 136. As discussed above, L_boost_s 148, is inductively coupled but electrically isolated from the primary winding L_boost_p 120 so that it can provide power to the voltage regulator 158. C1 150, D7 154, D6 152 and C2 156 form a typical charge pump circuit. L_boost_s 148 charges up C1 150 through D6 152, and C1 150 pumps out the stored energy to C2 156 through D7 154.

The microcontroller circuit 104 can include resistor R3 160 and resistor R4 162 to form a voltage sensing sensor 164 (v_boost_sense) across C2 156. V_boost_sense 164 can provide a signal to the microcontroller 136 to inform the microcontroller 136 of an input voltage signal. When input arcing happens, voltage across L_boost_p 120 and L_boost_s 148 can be switched on and off. When the voltage switches between on and off for the boost inductors, the voltage across C2 156 may drop and indicate input arcing. By detecting a potential voltage drop in C2 156 with V_boost_sense 164, these voltage changes can allow the identification of input arcing. Whenever the microcontroller 136 receives a signal from V_boost_sense 164 that the voltage across C2 156 has experienced a rapid change, the microcontroller 136 can react to the input arcing by forcing a delay on a next startup of the converter circuit 102 so that the startup time, and damage of those current surges can be reduced.

The system 100 can have two grounds, GND_PWR 168 and GND_LED 170. Those two ground are isolated from each other. L_boost_p 120 is on the primary ground, GND_PWR 168, side, and L_boost_s 148 is on the secondary ground, GND_LED 170, side. As discussed above, L_boost_s 148 can provide power to the voltage regulator 158, which is on the secondary ground side (GND_LED) 170.

When output arcing happens the output can cycle through open circuit (no-load), startup, and loaded (steady) states. As discussed above, rapid changing of the operating states may have the same effect on the converter circuit 102 and converter components as input arcing. Output arcing can cause current spikes to flow through, for example, the half-bridge switches Q2 128 and Q3 130. In the example system 100 of FIG. 1, when output arcing happens, the output may reach the voltage over-shoot level. For example, this voltage overshoot can be synchronized with output arcing based on a detected signal of voltage fluctuation across an LED 140. Using V_LED_sense can allow a microcontroller 136 to react to an output voltage sensing signal indicating that there may be output arcing.

As discussed above, the detection of arcing can result in the microcontroller 136 placing a delay on the operation of the converter. As used herein, the operation of the converter is the start-up or powering-up of the converter and the processing through the no-load, startup, and loaded states of the converter. If the microcontroller 136 senses an output voltage rapid change, this can be irregular and may be unlikely to happen during steady operating. However, in an arcing protected circuit, the microcontroller 136 may force a delay on restart. A delay in the restart or other controller operations can protect a half-bridge converter that may not go through as many stressful restarts as in an un-controlled or un-protected situation.

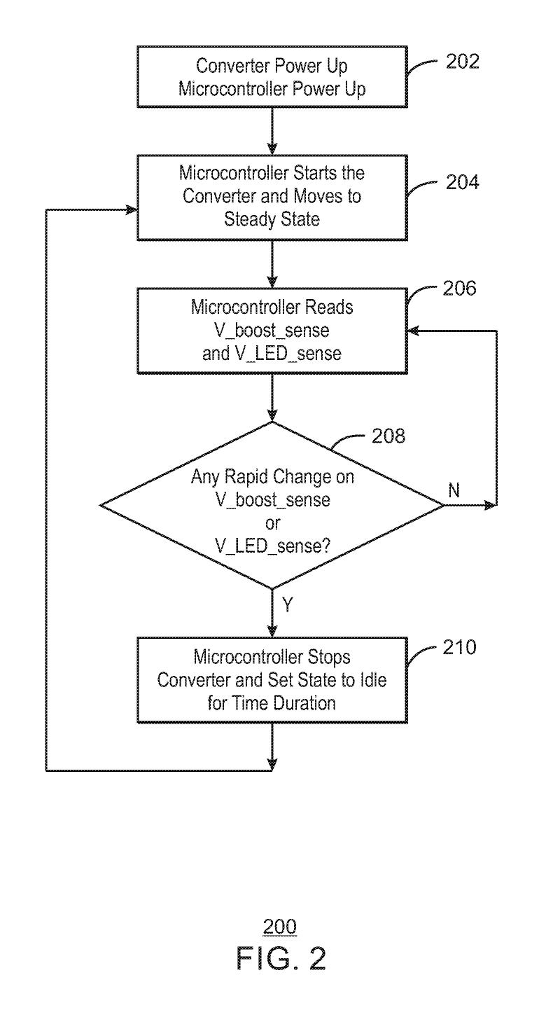

FIG. 2 is a process flow diagram of an example method 202 performed by a microcontroller to protect a driver from arcing. Process flow begins at block 202. In this example, the process flow may focus on the steps from the perspective of a microcontroller 136.

At block 202, the converter and the microcontroller may power up. At block 204, the micro controller may start the converter and move to steady state. At block 206, the micro controller reads the output sensors positioned to detect both input and output arcing. The voltage sensors can be V_boost_sense 164 and V_LED_sense 142. At block 208, a microcontroller may determine if there is any rapid change on the voltage sensors. If ‘no’, then process flow can proceed back to block 206 where the microcontroller reads the voltage sensors. If ‘yes’, process flow proceeds to block 210.

At block 210, the microcontroller can stop or delay the converter and set the state of the converter to an idle state. This delay or delay time (T) can be fixed or stated by a user. After the elapsing of delay time T, the microcontroller may attempt to resume a steady-state operation as seen in block 204.

FIG. 2 shows an input and output arcing protection control sequence of an example microcontroller. As shown above, by setting the restart delay time T, the switches and other components of the converter may experience fewer exposures and a lower power of exposures to start-up power and current stress.

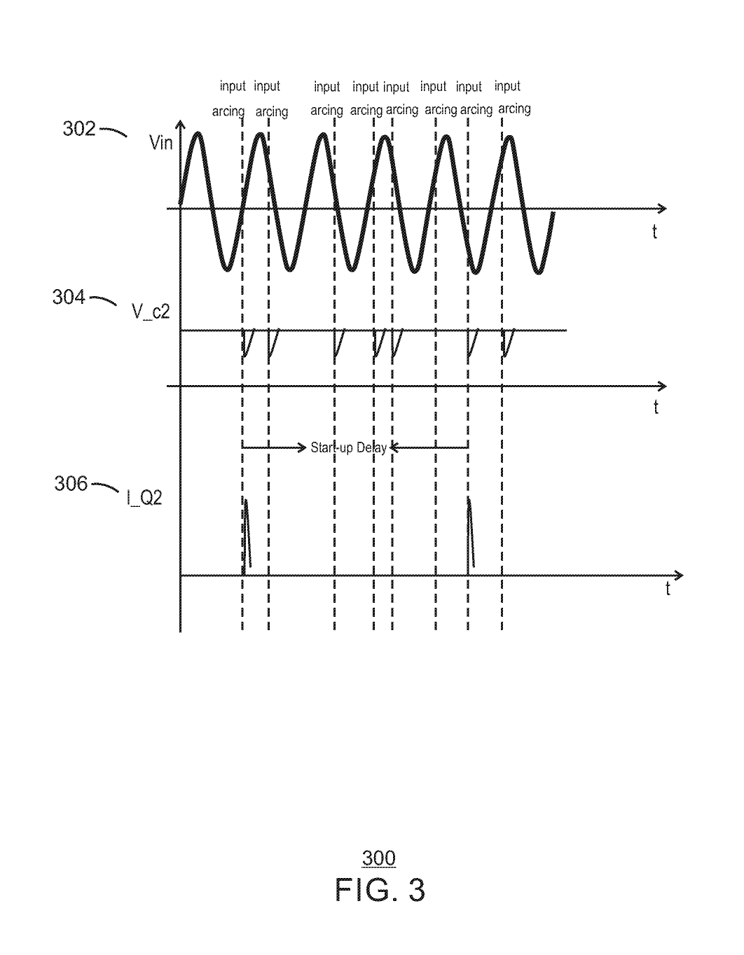

FIG. 3 is a drawing of an example detection of a signal 300 and delay to protect a driver from input arcing. Like numbered items correspond to the descriptions in FIG. 1.

As discussed above, the arcing can occur when a voltage fluctuates and these fluctuations can be frequent and damaging. To illustrate this, input voltage 302 (Vin) shows the input voltage to the microcontroller over time through the sensed input voltage 302. When input voltage 302 fluctuates, this can cause input arcing that could damage the converter or components of the converter, such as switches. For example, the input arcing could be taking place on the device shown in FIG. 1.

When input arcing occurs on the system 100 of FIG. 1, the input voltage 302 fluctuations could also cause a drop in the steady state voltage maintained at C2 156, this voltage level is abbreviated as V_c2 304 in FIG. 3. As shown in FIG. 3, V_c2 304 drops each time there is input arcing due to the fluctuations of input voltage 302. To protect the drivers and other components of the converter, a system with protection from input arcing could receive a signal from a voltage sensor across V2 156 and instruct a switch to delay start-up of the converter.

In FIG. 3, the high-side switch Q2 128 can delay start up and the inductance of Q2 (I_Q2) 306 can illustrate a start-up delay that would have otherwise included additional damaging arcing had the delay not been in effect. Upon sensing a first input arc the microcontroller can put a delay on the restart so that the start-time will be minimized and Q2 128 and Q3 130 may experience fewer high current and stressful start-ups.

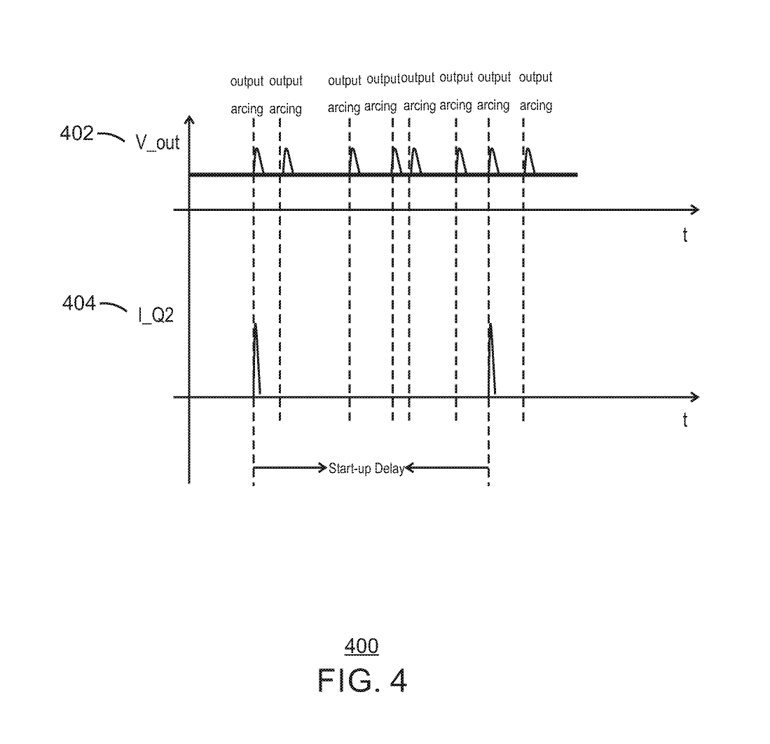

FIG. 4 is a drawing of an example detection of a signal 400 and delay to protect a driver from output arcing. Like numbered items are as described in FIG. 1.

As discussed above, the arcing can occur when a voltage fluctuates and these fluctuations can be frequent and damaging. To illustrate this, the output voltage 402 (V_out) shows the output voltage of the conversion circuit to the microcontroller over time. When V_out 402 fluctuates, this can cause output arcing that can damage the converter or components of the converter, such as switches. For example, the output arcing could be taking place on the device shown in FIG. 1. To protect the drivers and other components of the converter, a system with protection from output arcing could receive a signal from a voltage sensor and instruct a switch to delay start-up of the converter.

In FIG. 4, the high-side switch Q2 128 can delay start up and the inductance of Q2 (I_Q2) 404 can illustrate a start-up delay that would have otherwise included additional damaging arcing had the delay not been in effect. Upon sensing a first output arc, the microcontroller can put a delay on the restart so that the start-time will be minimized and Q2 128 and Q3 130 may experience fewer high current and stressful start-ups.

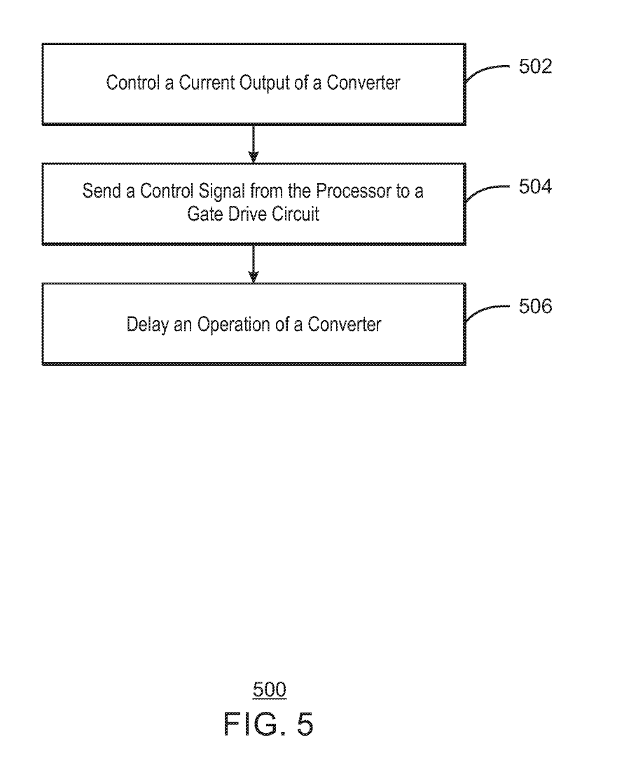

FIG. 5 is a process flow diagram of an example method 500 to protect a driver from arcing. Process flow begins at block 502.

At block 502, the method 500 for protecting a driver from arcing can include controlling a current output of a converter with a gate drive signal from a gate drive circuit to a connected high-side switch and a connected low-side switch. The gate drive circuit is part of a half-bridge resonant DC-DC converter for a light emitting diode driver.

At block 504, the method may include sending a control signal from a processor to a gate drive circuit when the processor receives an indication of arcing from a voltage sensor in the device. The voltage sensor can be an output voltage sensor that sends the processor an indication of arcing when the output voltage sensor detects an arcing frequency of voltage changes. The voltage sensor is an input voltage sensor installed in parallel with a boost inductor that may send the processor an indication of arcing when a voltage change is detected at the input voltage sensor.

At block 506, the operation by the converter is delayed when the gate drive circuit receives the control signal. The delay of the operation by the converter by the processor can be a delay of the start-up of the converter. The delay of the operation by the converter can be for a time duration that is adjustable by a user. The processor may delay a second attempt of the operation by the converter if the processor receives a second indication of arcing from a voltage sensor in the device. The processor may delay the operation by the converter by a first time duration and continue to delay operation by the converter by a second time duration, the second time duration longer than the first time duration. The repeated presence of arcing can suggest that a longer delay may be needed until the arcing ends, thus a second detection, especially immediately after a first detection and delay, could lead to a longer delay by the converter.

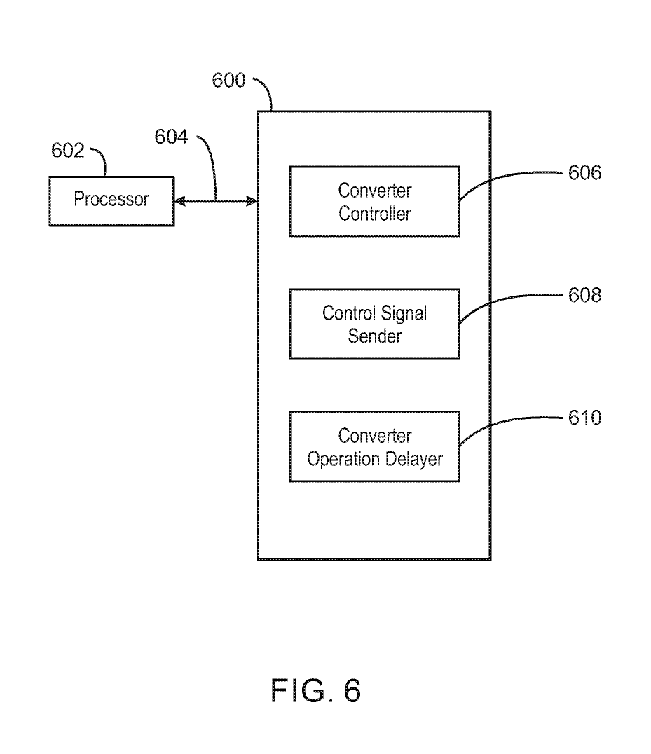

FIG. 6 is a drawing of an example computer-readable medium 600 storing instructions, that when executed on a processor protect a driver from arcing. The tangible, non-transitory, computer-readable medium including instructions that, when executed by a processor 602 can direct the processor 602 through a bus 604 to protecting a driver from arcing.

The computer-readable medium can include a converter controller 606. The converter controller 606 can direct the processor 602 to control a current output of a converter with a gate drive signal from a gate drive circuit to a connected high-side switch and a connected low-side switch. The gate drive circuit may be part of a half-bridge resonant DC-DC converter for a light emitting diode driver.

The computer-readable medium can include a control signal sender 608. The control signal sender 608 can direct the processor 602 to send a control signal from a processor to a gate drive circuit when the processor receives an indication of arcing from a voltage sensor in the device. The voltage sensor can be an output voltage sensor that sends the processor an indication of arcing when the output voltage sensor detects an arcing frequency of voltage changes. The voltage sensor is an input voltage sensor installed in parallel with a boost inductor that may send the processor an indication of arcing when a voltage change is detected at the input voltage sensor.

The computer-readable medium can include an operation by the converter delayer 610. The operation by the converter delayer 610 can direct the processor 602 to delay an operation by the converter when the gate drive circuit receives the control signal. The delay of the operation by the converter by the processor can be a delay of the start-up of the converter. The delay of the operation by the converter can be for a time duration that is adjustable by a user. The processor may continue to delay a second attempt of the operation by the converter if the processor receives a second indication of arcing from a voltage sensor in the device. The processor may delay the operation by the converter by a first time duration and a second attempt of the operation by the converter by a second time duration, the second time duration longer than the first time duration. The repeated presence of arcing can suggest that a longer delay may be needed until the arcing ends, thus a second detection, especially immediately after a first detection and delay, could lead to a longer delay by the converter.

What is claimed is:

1. A device to protect a driver from arcing, comprising:
a gate drive circuit connected to a high-side switch and a low-side switch to control to operation of a converter in the device;
a processor to send a control signal to the gate drive circuit when the processor receives an indication of arcing from a sensor in the device, the control signal to delay an operation by the converter.

2. The device of claim 1, wherein the delay of the operation by the converter by the processor is a delay of a start-up of the converter.

3. The device of claim 1, wherein the delay of the operation by the converter is for a time duration that is adjustable by a user.

4. The device of claim 1, wherein the gate drive circuit is part of a half-bridge resonant DC-DC converter for a light emitting diode driver.

5. The device of claim 1, wherein the voltage sensor is an output voltage sensor.

6. The device of claim 5, wherein the output voltage sensor sends the processor an indication of arcing when the output voltage sensor detects an arcing frequency of voltage changes.

7. The device of claim 1, wherein the voltage sensor is an input voltage sensor installed in parallel with a boost inductor.

8. The device of claim 7, wherein the input voltage sensor sends the processor an indication of arcing when a voltage change is detected at the input voltage sensor.

9. The device of claim 1, wherein the processor delays a second attempt of the operation by the converter if the processor receives a second indication of arcing from the voltage sensor in the device.

10. The device of claim 9, wherein the processor delays the operation by the converter by a first time duration and the second attempt of the operation by the converter by a second time duration, the second time duration longer than the first time duration.

11. A method for protecting a driver from arcing, comprising:
controlling a current output of a converter with a gate drive signal from a gate drive circuit to a connected high-side switch and a connected low-side switch;
sending a control signal from a processor to a gate drive circuit when the processor receives an indication of arcing from a sensor in the device; and
delaying an operation by the converter when the gate drive circuit receives the control signal.

12. The method of claim 11, wherein the delay of the operation by the converter by the processor is a delay of a start-up of the converter.

13. The method of claim 11, wherein the delay of the operation by the converter is for a time duration that is adjustable by a user.

14. The method of claim 11, wherein the gate drive circuit is part of a half-bridge resonant DC-DC converter for a light emitting diode driver.

15. The method of claim 11, wherein the voltage sensor is an output voltage sensor.

16. The method of claim 15, wherein the output voltage sensor sends the processor an indication of arcing when the output voltage sensor detects an arcing frequency of voltage changes.

17. The method of claim 11, wherein the voltage sensor is an input voltage sensor installed in parallel with a boost inductor.

18. The method of claim 17, wherein the input voltage sensor sends the processor an indication of arcing when a voltage change is detected at the input voltage sensor.

19. The method of claim 11, wherein the processor delays a second attempt of the operation by the converter if the processor receives a second indication of arcing from the voltage sensor in the device.

20. The method of claim 19, wherein the processor delays the operation by the converter by a first time duration and the second attempt of the operation by the converter by a second time duration, the second time duration longer than the first time duration.

21. A tangible, non-transitory, computer-readable medium comprising instructions that, when executed by a processor, direct the processor to protecting a driver from arcing, the instructions to direct the processor to:
control a current output of a converter with a gate drive signal from a gate drive circuit to a connected high-side switch and a connected low-side switch;
send a control signal from the processor to the gate drive circuit when the processor receives an indication of arcing from a voltage sensor in the device; and
delay an operation by the converter when the gate drive circuit receives the control signal.

22. The computer-readable medium of claim 21, wherein the delay of the operation by the converter by the processor is the delay of a start-up of the converter.

23. The computer-readable medium of claim 21, wherein the delay of the operation by the converter is for a time duration that is adjustable by a user.

24. The computer-readable medium of claim 21, wherein the gate drive circuit is part of a half-bridge resonant DC-DC converter for a light emitting diode driver.

25. The computer-readable medium of claim 21, wherein the voltage sensor is an output voltage sensor.

26. The computer-readable medium of claim 25, wherein the output voltage sensor sends the processor an indication of arcing when the output voltage sensor detects an arcing frequency of voltage changes.

27. The computer-readable medium of claim 21, wherein the voltage sensor is an input voltage sensor installed in parallel with a boost inductor.

28. The computer-readable medium of claim 27, wherein the input voltage sensor sends the processor an indication of arcing when a voltage change is detected at the input voltage sensor.

29. The computer-readable medium of claim 21, wherein the processor delays a second attempt of the operation by the converter if the processor receives a second indication of arcing from the voltage sensor in the device.

30. The computer-readable medium of claim 29, wherein the processor delays the operation by the converter by a first time duration and the second attempt of the operation by the converter by a second time duration, the second time duration longer than the first time duration.
